(19) United States
(12) Patent Application Publication
(10) Pub. No.: US 2014/0310620 A1
(43) Pub. Date: Oct. 16, 2014

(54) DETERMINING FOREGROUND AND BACKGROUND COLOR COMBINATION FOR A USER INTERFACE ELEMENT IMPORTED FROM ANOTHER USER INTERFACE

(71) Applicant: NIIT TECHNOLOGIES LTD., New Delhi (IN)

(72) Inventors: Udayan Banerjee, Bangalore (IN); Eswaran Narasimhan, Bangalore (IN)

(73) Assignee: NIIT Technologies Ltd., New Delhi (IN)

(21) Appl. No.: 13/862,474

(22) Filed: Apr. 15, 2013

(51) Int. Cl. G06F 3/0484

(52) U.S. Cl. CPC G06F 3/0484
USPC 715/762

(57) ABSTRACT

An aspect of the present invention facilitates development of user interfaces of applications. In one embodiment, a user is enabled to select a user interface (UI) element from a source interface, the UI element being displayed using a source foreground color in a backdrop of a source background color in the source interface. Upon receiving a target background color forming a backdrop to the UI element in a target interface, a target foreground color is computed based on the target background color and a color difference between the source foreground color and the source background color. The selected UI element is then displayed in the target interface using the (computed) target foreground color and the (received) target background color.

### BACKGROUND OF THE INVENTION

1. Technical Field

The present disclosure relates to software systems, and more specifically to determining foreground and background color combination for a user interface element imported from another user interface.

2. Related Art

A user interface (UI) refers to a technological mechanism in which a user is enabled to interact with an application. Such interaction typically entails receiving inputs from the user and rendering (displaying, playing sounds, etc.) the outputs generated, typically by processing of the inputs.

User interfaces contain user interface elements (hereafter elements) for facilitation of inputs and outputs/rendering. Each element is displayed within a display area corresponding to the UI, and provides the corresponding input and/or output functionality, as is well known in the relevant arts.

Each element may be viewed as being displayed using a combination of foreground and background colors. Background color refers to the general color that forms a backdrop to the element, while foreground color refers to the predominant color used for displaying of the element itself. In general, an appropriate combination of foreground and background colors is chosen to ensure one or more of considerations such as whether the element is readable, draws a desired level of attention, and is aesthetically pleasing to the eye.

There are often situations in which an element is imported from a pre-existing UI, for example to reuse the element in a new UI. Such importing may be performed for providing a corresponding functionality in the new UI. It may accordingly be desirable to determine the specific foreground and background color combination for the imported element in the new UI.

### BRIEF DESCRIPTION OF THE DRAWINGS

Example embodiments of the present invention will be described with reference to the accompanying drawings briefly described below.

FIG. 1 is a block diagram illustrating an example environment (computing system) in which several aspects of the present invention can be implemented.

FIG. 2 is a flow chart illustrating the manner in which a foreground and background color combination for a user interface element imported from another user interface is determined according to an aspect of the present invention.

FIG. 3 is a flow chart illustrating the manner in which a target foreground color of an element is computed based on a target background color, a source background color and a source foreground color according to an aspect of the present invention.

FIGS. 4A-4D together illustrates a user interface development environment (IDE), provided according to several aspects of the present invention, which determines the color combination for an imported user interface element in one embodiment.

FIG. 5 illustrates the calculations performed as part of computing a target foreground color of an element based on a target background color, a source background color and a source foreground color in one embodiment.

FIG. 6A depicts portions of a specification specifying the details of a pre-existing user interface (from which user elements can be imported) in one embodiment.

FIG. 6B depicts portions of a specification specifying the details of a new user interface sought to be created by importing user interface elements from other pre-existing user interfaces in one embodiment.

FIG. 7 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

1. Overview

An aspect of the present invention facilitates development of user interfaces of applications. In one embodiment, a user is enabled to select a user interface (UI) element from a source interface, the UI element being displayed using a source foreground color in the backdrop of a source background color in the source interface. Upon receiving a target background color forming a backdrop to the UI element in a target interface, a target foreground color is computed based on the target background color and a color difference between the source foreground color and the source background color. The selected UI element is then displayed in the target interface using the (computed) target foreground color and the (received) target background color.

Several aspects of the present invention are described below with reference to examples for illustration. However, one skilled in the relevant arts will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

2. Example Environment

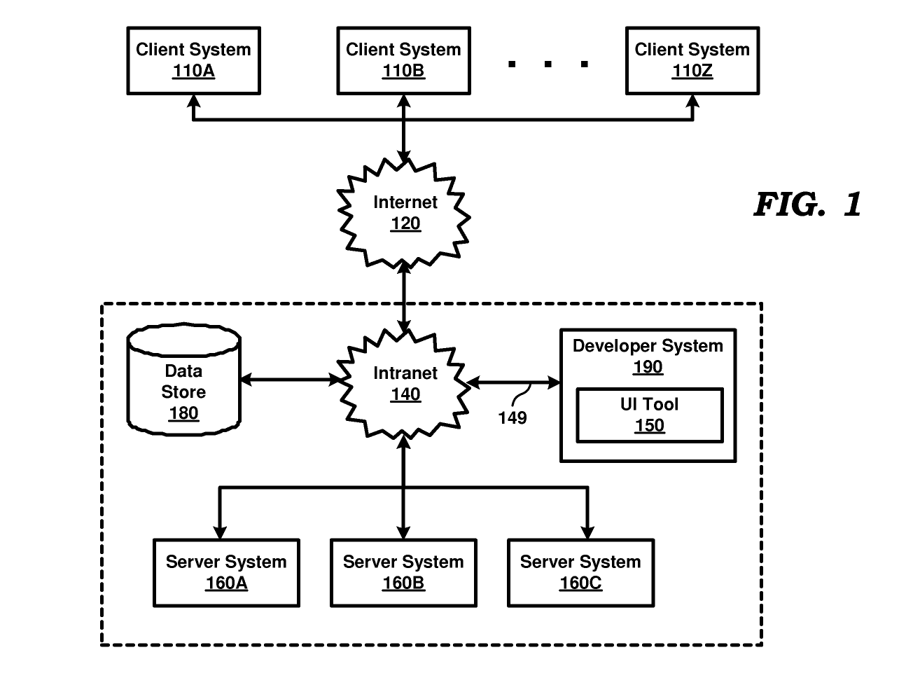

FIG. 1 is a block diagram illustrating an example environment (computing system) in which several aspects of the present invention can be implemented. The block diagram is shown containing client systems 110A-110Z, Internet 120, intranet 140, server systems 160A-160C, data store 180 and developer system 190 (in turn, shown containing UI tool 150).

Merely for illustration, only representative number/type of systems is shown in FIG. 1. Many environments often contain many more systems, both in number and type, depending on the purpose for which the environment is designed. Each block of FIG. 1 is described below in further detail.

Intranet 140 represents a network providing connectivity between server systems 160A-160C, data store 180, and developer system 190, all provided within an enterprise (shown with dotted boundaries). Internet 120 extends the connectivity of these (and other systems of the enterprise) with external systems such as client systems 110A-110Z. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by intranet 140 and Internet 120.

Data store 180 represents a non-volatile (persistent) storage facilitating storage and retrieval of a collection of data by applications executing in server systems 160A-160C (and also developer system 190). Data store 180 may be implemented as a database server using relational database technologies and accordingly provide storage and retrieval of data using structured queries such as SQL (Structured Query Language). Alternatively, data store 180 may be implemented as a file server providing storage and retrieval of data in the form of files organized as one or more directories, as is well known in the relevant arts.

Each of client systems 110A-110Z represents a system such as a personal computer, workstation, mobile device, tablets, etc., used by users to generate (server) requests directed to applications executing in server systems 160A-160C. The requests may be generated using appropriate user interfaces such as web pages provided by an application executing in a server system, a native user interface provided by a portion of the application downloaded from the server system, etc. In general, a client system requests an application for performing desired tasks and receives corresponding responses containing the results of performance of the requested tasks. Each server request is sent in the form of an IP packet directed to the desired server system (and application), with the IP packet including data identifying the desired tasks in the payload portion.

Each of server systems 130 represents a server, such as a web/application server, executing (enterprise) applications capable of performing tasks requested by users using one of client systems 110A-110Z. A server system may use data stored internally (for example, in a non-volatile storage/hard disk within the server system), external data maintained in data store 180 and/or data received from external sources (e.g., from the user) in performing such tasks. The server system then sends the result of performance of the tasks to the requesting client system (one of 110A-110Z). The results may be accompanied by specific user interfaces (e.g., web pages) for displaying the results to the requesting user.

Developer system 190 represents a system such as a personal computer, workstation, mobile station, etc., used by users/developers to create (and/or modify) applications executing in server systems 160A-160C. As is well known, the software instructions are commonly specified using a high-level programming language such as C, C++, Java, C#, etc., with the specified instructions then converted/compiled into executable code (e.g., binary code executed by a processor, intermediate code executed by a virtual machine, etc.) before being deployed on one or more of server systems 160A-160C. In particular, developers of an application specify software instructions designed to provide a corresponding user interface and perform specific tasks requested by the user using the provided user interface.

A user interface development environment (or IDE) is often provided to facilitate developers to develop desired user interfaces. In general, an IDE provides various pre-configured user interface elements (hereafter elements) that may be selected, customized and/or placed by the developers on a user interface sought to be created/developed. Examples of such pre-configured “base” elements are button, text field, image, label, tab, scroll bar, etc. as is well known in the arts. A developer accordingly constructs a user interface by selecting the desired elements, customizing the selected elements (by changing the properties such as background and foreground colors) and then placing the selected elements at desired locations of the user interface.

It may be appreciated that the developer in such an environment is restricted to only those UI elements provided by the IDE. Furthermore, the developer is required to spend considerable time and resources to construct each UI from the base elements. As noted in the Background section, some IDEs facilitate the developers to import (customized and/or placed) elements from the pre-existing user interfaces of other applications. An example IDE that facilitates such importing of user interface elements from other user interfaces is described in US Application entitled “Simplifying Development Of User Interfaces Of Applications”, application Ser. No. 13/606,047, filed on: 7 Sep. 2012, First Named Inventor: Udayan Banerjee, which is incorporated in its entirety herewith.

One challenge to importing an element from another UI is that the combination of foreground and background colors used for the element in another user interface may not be suitable for a new UI being constructed by the developer. For example, using the same foreground color for the element when placed in the new UI having a different background color may cause the element to be not readable, or not be aesthetically pleasing to the eye. It may accordingly be desirable to determine the specific foreground and background color combination for the imported element in the new UI.

UI (user interface) tool 150, provided according to several aspects of the present invention, determines the foreground and background color combination for a user interface element imported from another user interface, while overcoming some of the drawbacks noted above. Though UI tool 150 is shown executing in developer system 190, in alternative embodiments, UI tool 150 may be implemented as an independent module external to the systems of FIG. 1. The manner in which UI tool 150 determines a color combination for an imported user interface element is described below with examples.

3. Determining a Color Combination For an Imported Element

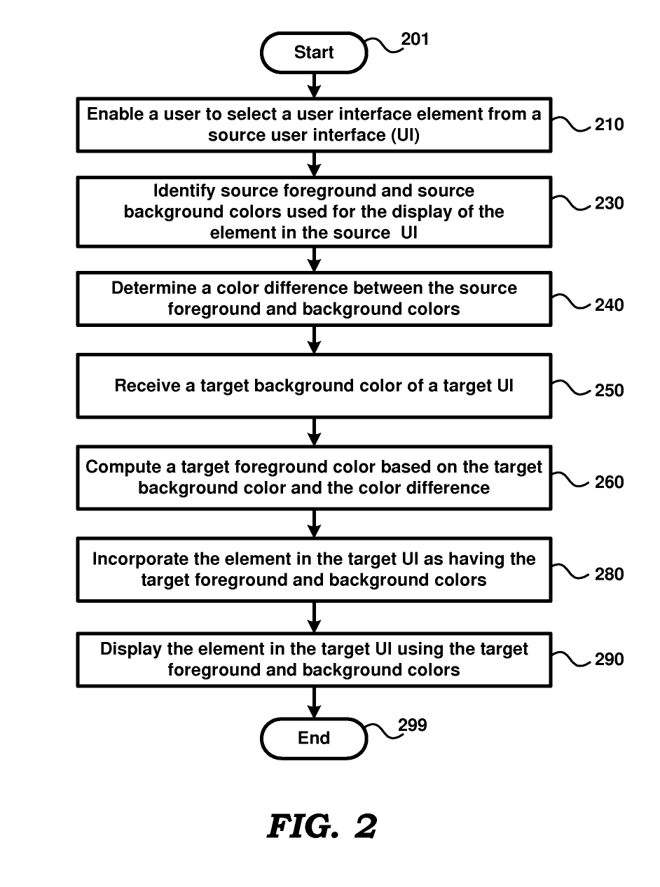

FIG. 2 is a flow chart illustrating the manner in which a foreground and background color combination for a user interface element imported from another user interface is determined according to an aspect of the present invention. The flowchart is described with respect to FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, UI tool 150 enables a user/developer to select a user interface element from a source UI (from which the element is sought to be imported). UI tool 150 may provide a corresponding IDE for facilitating the selection of the element by the user. The source UI and IDE may be displayed on a display unit (not shown) associated with developer system 190.

In step 230, UI tool 150 identifies the source foreground and source background colors used for the display of the selected element in the source UI. In one embodiment, each UI is specified by a corresponding specification (maintained in data store 180) indicating the details of presentation (such as the color, font, width, height, etc.) of each element of the UI, the behavior/functionality of each element and the events to which each element is designed to respond. UI tool 150 may accordingly inspect the specification of the source UI to identify the foreground and background colors of the selected element. However, alternative techniques may be employed to identify such colors, without departing from the scope and spirit of several aspects of the present invention, as will be apparent to a skilled practitioner by reading the disclosure herein.

In step 240, UI tool 150 determines a color difference between the source foreground and source background colors. Typically, a color difference between the foreground and background colors is chosen to provide a desired level of highlight or visually perceptible emphasis (either more or less) to the information sought to be conveyed via the element. The color difference can be measured as a difference in the constituent colors (e.g., as RGB values, YUV values, etc.) forming each of the foreground and background colors.

In step 250, UI tool 150 receives a target background color for the selected element in the target UI. The target background color may either be received from the developer creating the target UI or may be identified (for example, by examining the specification of the target UI) as the general color that forms the backdrop to the selected element, at the position the selected element is placed in the target UI.

Since the target background color may be different from the source background color, it may be desirable to determine a target foreground color such that the imported element conveys a similar level of highlight or visually perceptible emphasis as in the source UI.

Thus, in step 260, UI tool 150 computes a target foreground color based on the target background color and the previously determined color difference. The target foreground color is computed such that the color difference between the computed foreground color and the received background color is similar to the color difference determined in step 240. By ensuring the element has a color difference in the target UI similar to the difference in the source UI, the element may be provided with a similar level of highlight in the target UI as well.

Though the above noted steps of 250 and 260 are described with respect to receiving of a target background color and then computing the target foreground color, it may be appreciated that in an alternative embodiment, a target foreground color may be received in step 250 with UI tool 150 then determining a target background color based on the received target foreground color and the previously determined color difference, as will be apparent to a skilled practitioner by reading the disclosure herein.

In step 280, UI tool 150 incorporates the element in the target UI as having the target foreground and background colors. In the embodiment noted above, such incorporation entails including the element in the specification of the target UI with the corresponding values for the target foreground and background colors.

In step 290, UI tool 150 displays the element in the target UI using the target foreground and background colors. The target UI may be displayed on a display unit (not shown) associated with developer system 190 or later in other systems when the target UI is deployed in such other systems. The flow chart ends in step 299.

Thus, a developer is facilitated to import an element from another/source UI, and thereafter display the imported element using an appropriate combination of a foreground and background colors in the target UI. It may be appreciated that the computation of the target foreground color based on the received target background color and the previously determined color difference may be performed in any convenient manner. One manner in which UI tool 150 may compute the target foreground color according to an aspect of the present invention is described below with examples.

4. Computing a Target Foreground Color

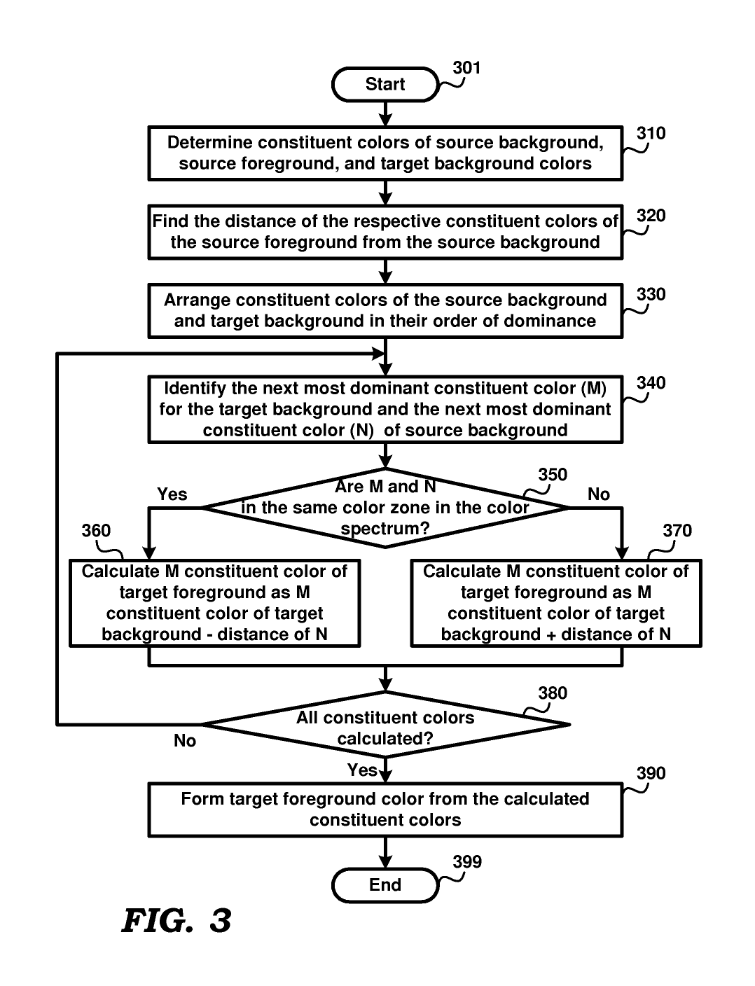

FIG. 3 is a flow chart illustrating the manner in which a target foreground color of an element is computed based on a target background color, a source background color and a source foreground color according to an aspect of the present invention. The flowchart is described with respect to FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 301, in which control immediately passes to step 310.

In step 310, UI tool 150 determines constituent colors of source background, source foreground, and target background colors. In one embodiment, the red (R), green (G) and blue (B) constituent colors are determined for each of the colors. Each of the constituent color is a digital value from 0 to 255 with the triplet (R,G,B) of digital values representing a corresponding color, as is well known in the arts. In the below description, it is assumed that the triplet of constituent colors of the source background is (R0,G0,B0), the source foreground is (R1,G1,B1) the target background is (R2,G2,B2) and that the target foreground to be computed is (R3,G3,B3).

In step 320, UI tool 150 finds the distance of the constituent colors of the source foreground from the respective constituent colors of the source background. The distance provides a quantitative measure of the color difference between the source foreground and the source background. UI tool 150 may accordingly find the distance of red color (DR) as the difference between the respective red colors of source foreground and source background |R1−R0|, distance of green color (DG) as |G1−G0| and distance of blue color (DB) as |B1−B0|, where “| |” is the absolute value operator.

In step 330, UI tool 150 arranges the constituent colors of the source background and target background in their order of dominance (with a higher digital value indicating more dominance over a lower digital value). For example, based on the digital values of the constituent colors, UI tool 150 may arrange the constituent colors of the source background in the order R0, G0 and B0 (where R0>=G0>=B0) and the constituent colors of the target background in the order G2, B2 and R2 (where G2>=B2>=R2).

In step 340, UI tool 150 identifies the next most dominant color (M) for the target background and the next most dominant color (N) of source background. In the above noted example, UI tool 150 identifies green as color M and red as color N. During subsequent iterations, the next pairs of dominant colors (blue and green), and then (red and blue) are respectively identified as colors M and N.

In step 350, UI tool 150 determines whether (the digital values) of colors M and N are in the same zone in the color spectrum (the range of values from 0 to 255). In one embodiment, the color spectrum is divided into two zones, a first zone between 0 to 127 and a second zone between 128 and 255. The values of colors M and N may accordingly be compared to the value 127 to identify the specific zone to which each color belongs. Control passes to step 360, if M and N are determined to be in the same zone (that is, if both are less than or equal to 127 or both are greater than 127) and to step 370 otherwise.

In step 360, UI tool 150 calculates the M color of target foreground as M color of target background+distance of N (where ‘+’ indicates addition), and control passes to step 380. In step 370, UI tool 150 calculates M color of target foreground as M color of target background−distance of N (where ‘−’ indicates subtraction) and control passes to step 380.

In other words, the color of the target foreground is computed based on the dominant color in the target background and the difference in the dominant color in the source background. In the above noted example, the green color of target foreground (G3) is computed either as G2+DR (if in the same zone) and as G2−DR (otherwise), where G2 is the green constituent color of the target background and the DR is the difference in the red constituent color between the source foreground and source background.

It may be appreciated that by subtracting when M and N are in the same zone and adding when in different zones, the constituent colors may be maintained between the values 0 to 255. However, in a scenario that the calculated (constituent color) value is outside the range of 0 to 255, the calculated value is truncated/rounded off to a nearest value within the range. In other words, the calculated value is set to 0 if the value is below 0 and is set to 255 if the value is above 255.

In step 380, UI tool 150 checks whether all the constituent colors are calculated. If all the constituent colors are not yet calculated, control pass to step 340, where the next pair of dominant constituent colors are identified and steps 360, 370/380 are repeated until all the constituent colors of the target foreground are calculated.

In the above noted example, during subsequent iterations, UI tool 150 calculates the blue constituent color B3 either as B2−DG or B2+DG (based on whether B2 and G0 are in the same zone or not) and the red constituent color R3 either as R2−DB or R2+DB (based on whether R2 and B0 are in the same zone or no). After all the constituent colors are calculated, control passes to step 390. In step 390, UI tool 150 forms the target foreground color from the calculated constituent colors as the triplet (R3,G3,B3), as noted above. The flow chart ends in step 399.

Thus, UI tool 150 computes a target foreground color of an element based on a target background color and a color difference between a source background color and a source foreground color. The manner in which UI tool 150 determines a color combination for an imported element according to the steps of FIGS. 2 and 3 is described below with examples.

5. Illustrative Example

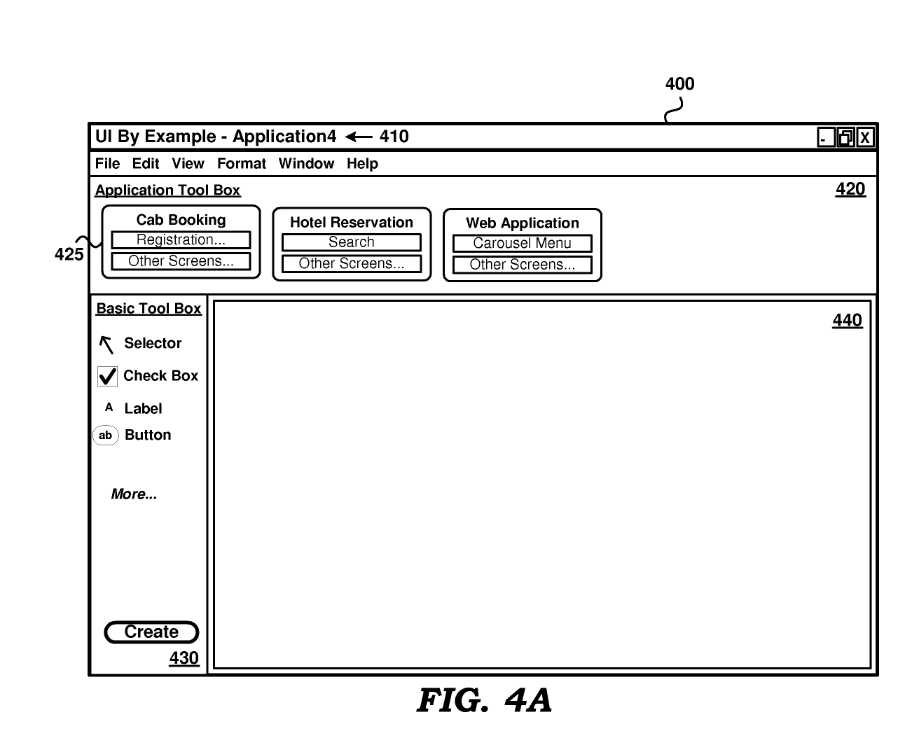

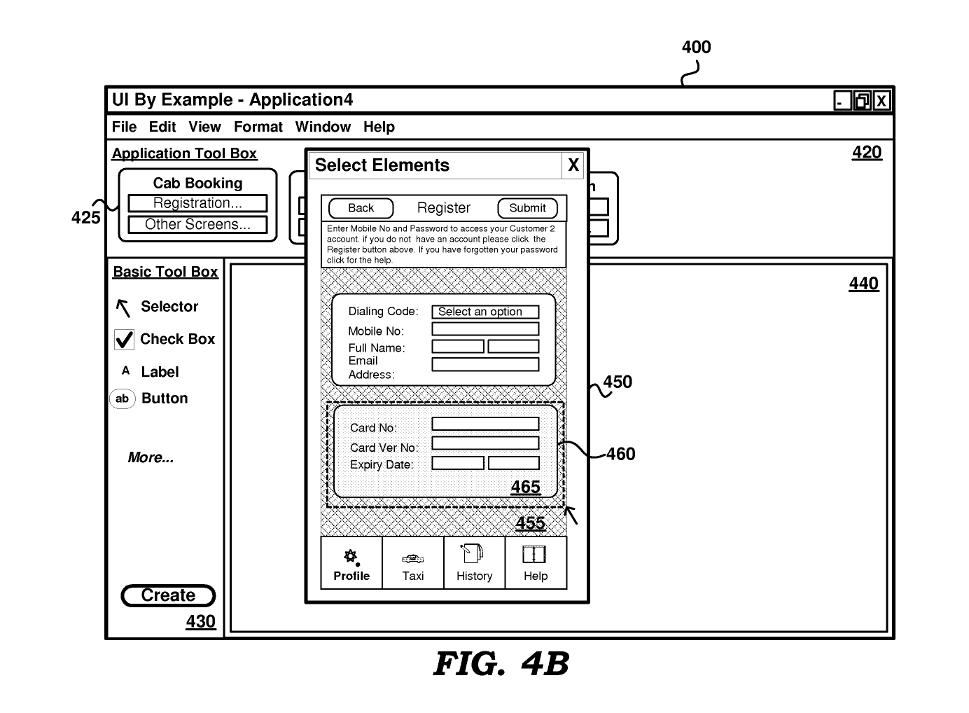

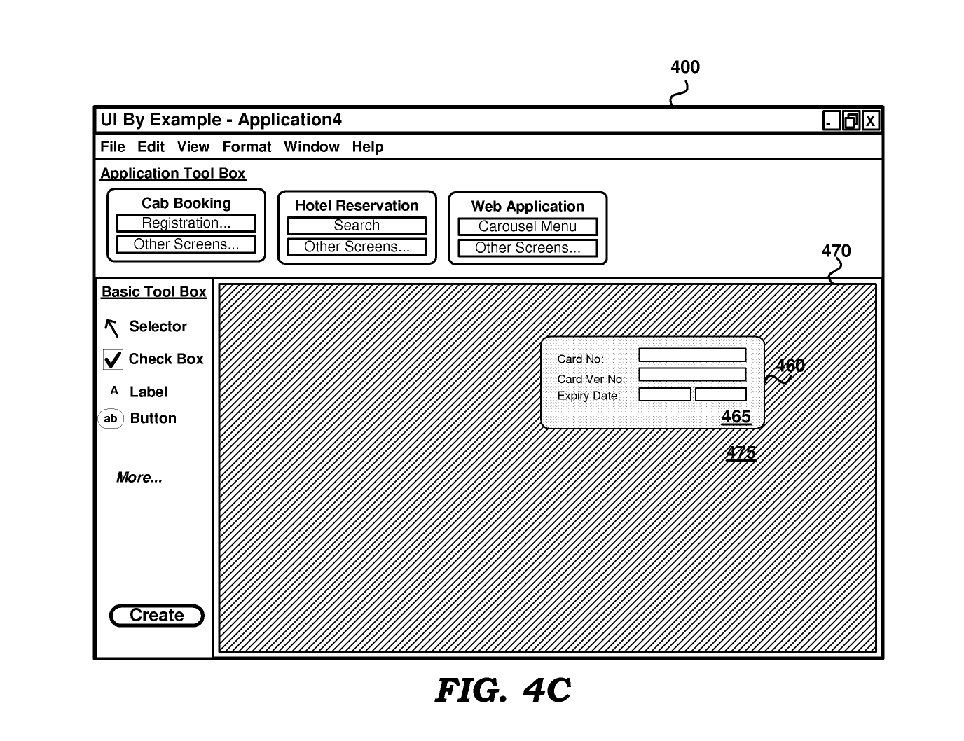

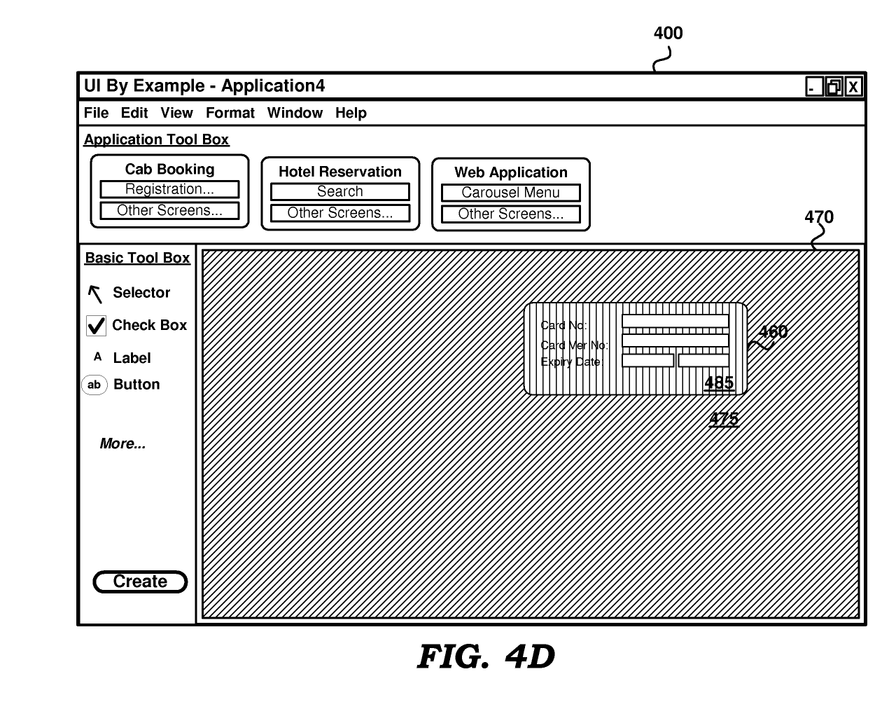

FIGS. 4A-4D, 5 and 6 together illustrate the manner in which a color combination of a user interface element imported from another user interface is determined in one embodiment. For illustration, the development of user interfaces of mobile applications using the elements provided by other mobile applications is described in detail below. However, the features of the present invention may be implemented for development of user interface other types (such as desktop, web, etc.) of applications as well, as will be apparent to one skilled in the relevant arts by reading the disclosure herein. Each of the Figures is described in detail below.

FIGS. 4A-4D together illustrates a user interface development environment (IDE), provided according to several aspects of the present invention, which determines the color combination for an imported user interface element in one embodiment. Display area 400 depicts various portion of a user interface provided as part of the IDE by UI tool 150 (in response to a user/developer indicating that a new/target UI is sought to be created). Display area 400 may be displayed on a display unit (not shown in FIG. 1) associated with developer system 190.

Referring to FIG. 4A, display area 410 indicates that a developer is creating a new application named “Application4”. Display area 420 displays the currently available user interfaces of various mobiles applications (e.g., for which corresponding specifications are maintained in data store 180). UI tool 150 may accordingly retrieve the specifications of the user interfaces of each application, determine the various distinct user interfaces or pages and then display the determined pages as corresponding selectable options in display area 420.

Display area 425 depicts one such selectable option corresponding to a cab booking application, where the name of the application is shown in a box, and the various user interfaces/screens (such as registration screen) provided by the application are shown as selectable options within the box. The “Other Screens” option enables the user/developer to view additional screens provided by the application. Similar display areas corresponding to user interfaces of a hotel reservation application and a web application are also shown as part of display area 420.

Display area 330 displays various pre-configured base elements that can be added to the new user interface (sought to be created), in addition to elements selected and imported from the various other UIs. Display area 340 represents a “canvas” in which the developer may incorporate the desired elements for creating a new user interface of a new application. The canvas is shown empty indicating that the user has not added any elements. The developer may accordingly choose a user interface (by selecting/clicking the corresponding selectable option in display area 320) for selecting elements to be imported, as described below with examples.

6. Importing User Interface Elements

Referring to FIG. 4B, display area 450 represents a portion of a screen displayed by UI tool 150, in response to a user selecting/clicking a selectable option in display area 420. In particular, display area 450 is displayed in the form of a pop-up window (overlaying display area 400) which shows the user interface corresponding to selectable option clicked by the developer. Display area 450 is shown displaying a user interface corresponding to a “Registration” screen of the cab booking application, in response to the user selecting the “Registration” selectable option in the Cab Booking box 425 in display area 420.

Though not shown, it should be appreciated that each of the elements in display area 450 is displayed with a corresponding foreground and background color combination. Some of elements may be shown using the same or similar color combination, such as the “Back” and “Submit” buttons displayed at the top of display area 450, while other elements may be shown with a different contrasting color combination (so as to grab the attention of the user), such as “Help” button at the bottom right corner of display area 450. Example of such foreground-background color combinations are black-white, blue-brown, etc.

Element 460 represents a compound element (“panel”) containing two or more base elements. In particular, element/panel 460 is shown containing three labels such as “Card No.”, four text fields and a rounded rectangle enclosing the other elements of panel 460. The background color of such a compound element is the color that forms a backdrop to the compound element, while the foreground color is the predominant color of the compound element (and which in turn, represents the background color for the base elements contained in the compound element). As such, color 465 (shown as dotted pattern) represents the (source) foreground color of panel 460, while color 455 (shown as crosshatched pattern) represents the (source) background color of panel 460.

The developer may select the specific elements from the UI of display area 450 for importing into the new UI. The selection of the specific elements may be performed in a known way. For example, a developer may drag the mouse pointer to create a selection (as indicated by the dotted rectangle) around the outside of all the elements that the developer wishes to include in the selection. Thus, display area 450 indicates that the developer has selected panel 460 for importing into the new UI. The selection of a compound element (panel 460) implies that all the base elements (three labels, four text fields, and rounded rectangle) contained in the compound element are also sought to be selected and imported into the new UI.

In response to the developer selecting/importing specific elements, UI tool 150 updates the new UI sought to be created, in particular the canvas of display area 440, with the selected user interface elements, as described below with examples.

Referring to FIG. 4C, display area 470 depicts the canvas (of display area 440) updated with the user interface elements selected/imported by the developer. In particular, display area 470 is shown containing panel 460 (and corresponding included base elements) selected and imported from the registration screen of the cab booking application (as shown in display area 450 of FIG. 4A). Panel 460 is shown as being displayed with the same (source) foreground color 345 as in display area 450.

7. Determining Target Foreground Color

After importing, a developer may change the color of canvas 470 (and correspondingly the background color of panel 460) to a new color 475 (shown as slashed pattern in FIG. 4C). The changing of the (target) background color may send an indication to UI tool 150 that the target foreground color of panel 460 corresponding to the changed target background color (and also the source color combination) is to be determined.

Alternatively, assuming that the developer has already specified a target background color for canvas 440/470, the indication may be sent to UI tool 150 in response to the placing of the imported element (460) in the canvas. In another embodiment, a developer may manually send (by selecting an option/button, not shown) the indication that the foreground color of panel 460 is to be determined based on an existing or possible target background color and a previous color difference between the source foreground color (465) and the source background color (455).

In response to such an indication, UI tool 150 computes a target foreground color for the imported element based on the target background color (475), the source foreground color (465) and the source background color (455), as describe below with examples.

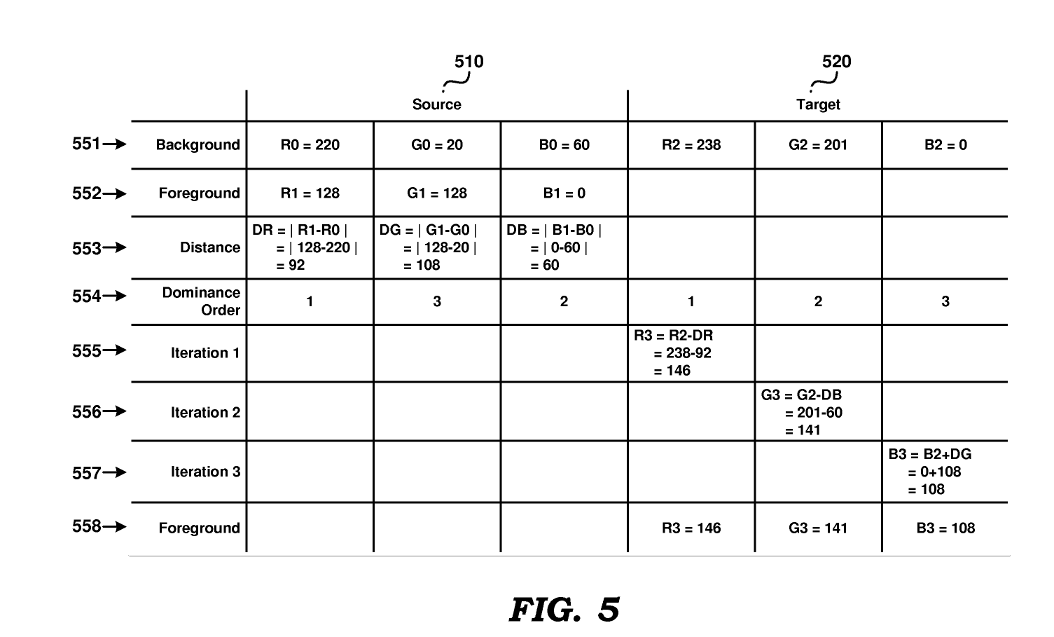

FIG. 5 illustrates the calculations performed as part of computing a target foreground color of an element based on a target background color, a source background color and a source foreground color in one embodiment. Broadly, columns 510 and 520 indicate the values and calculations performed using the constituent (red, green, blue) colors of the background and foreground colors in the source UI and target UI respectively.

Each of rows 551-558 specifies the details of a corresponding value/calculation step performed with the source and target colors. Row 551 indicates the source background color (455) as being (R0=220, G0=20, B0=60) and the target background color (475) as (R2=238, G0=201, B0=0), while row 552 indicates the source foreground color (465) as being (R1=128, G1=128, B1=0). Row 553 specifies the determination of the distances between the constituent colors of the source background and the source foreground colors. It may be observed that the absolute values of the distances are obtained in this step.

Row 554 specifies a respective order of dominance among the constituent colors of each of the source background color and the target background color. In particular, row 554 indicates that the order of dominance for the source background color is red, blue and green, while the order of dominance for the target background color is red, green and blue. As noted above, the order of dominance is determined based on the values of the constituent colors, with a constituent color with a higher value (such as red with value 220) having a higher position (1) as compared to the position (2) of another constituent color with a lower value (such as blue with value 60).

Each of rows 555-557 specifies the calculations performed during a corresponding iteration of the flow chart of FIG. 3. Thus, in row 555 during the first iteration, the value of the target dominant color (M=red) of the target foreground color (that is, R3) is calculated as the value of the target dominant color of the target background color (that is, R2)−the difference corresponding to the source dominant color (that is, DR since N=red). The value as subtracted since the values 238 and 220 for the source and target dominant colors are both in the same zone (127 to 255) of the color spectrum. Similarly, the other rows 556 and 557 specify the details of the subsequent iterations during which the values of the green and blue constituent colors are calculated. In row 558, the target foreground color (R3=146, G3=141, B3=108) is formed from the calculated constituent colors.

Thus, UI tool 150 computes a target foreground color of an element (panel 460) based on a target background color, a source background color and a source foreground color. UI tool 150 may then display the user interface element (panel 460) using the computed foreground target color.

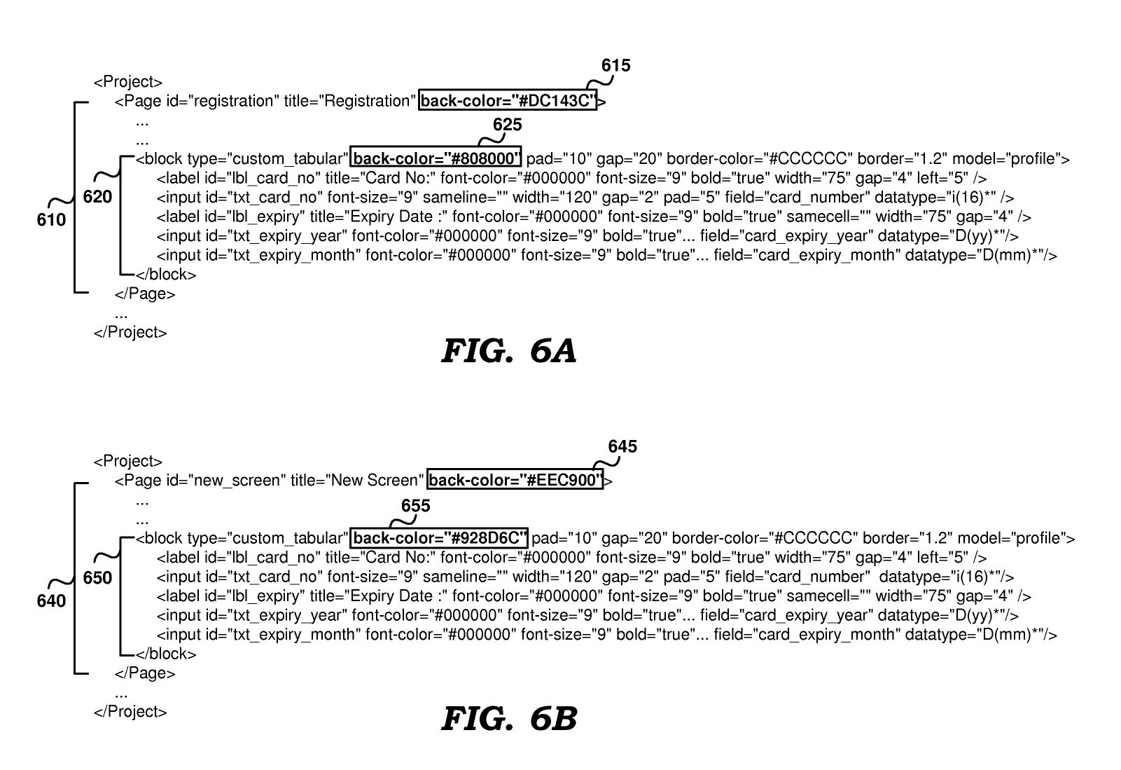

Referring to FIG. 4D, display area 470 depicts the canvas (of FIG. 4C) updated with the computed target foreground color 485 (shown as vertical lines pattern). In particular, the foreground color of panel 460 is shown using the computed foreground color 485 on a backdrop of the background color 475. It may be appreciated that the new foreground color 485 may provide a better color difference/contrast with background color 475 in comparison to the previous foreground color 465 (as shown in FIG. 6C).

Thus, UI tool 150 determines a target foreground and background color combination for a user interface element (panel 460) imported from another UI, in particular based on a source foreground and background color combination for the element in the another UI.

As noted above, in one embodiment, each UI is specified by a corresponding specification (maintained in data store 180) indicating the details of presentation (such as the color, font, width, height, etc.) of each element of the UI, the behavior/functionality of each element and the events to which each element is designed to respond. The manner in which the user interfaces of FIGS. 4A-4D may be maintained as corresponding specifications is described below with examples.

8. Specifications of User Interfaces

Each of FIGS. 6A and 6B respectively depicts portions of specifications specifying the details of different user interfaces in one embodiment. The specification of FIG. 6A specifies the details of a pre-existing user interface from which user elements can be imported, in particular, the registration screen (shown in display area 450) of the cab booking application. The specification of FIG. 6B specifies the details of a new user interface, in particular, the new UI shown in display area 470 of FIG. 4D, sought to be created by importing user interface elements from other pre-existing user interfaces.

The specification is shown as being maintained according to extensible markup language (XML), for illustration. However, in alternative embodiments, the specifications may be maintained using other data formats such as HTML (hypertext markup language) and/or using other data structures (such as a table in a relational database), as will be apparent to one skilled in the relevant arts by reading the disclosure herein.

Referring to FIG. 6A, various data portions (XML elements “<button>”, “<label>”, etc.) are shown indicating the details of the various user interface elements such as buttons, labels, etc. in the pre-existing user interface. It may be observed that the data portions are shown specifying various display properties such as color, back-color, title, etc. of the element, and also the non-display properties (such as id, type, etc.). The methods and events associated with each element may similarly be specified (for example, using other XML elements, not shown).

Data portion 610 (XML element “<page>”) specifies the details of the “registration” page/screen in the user interface of the cab booking application, while data portion 620 (XML element “<block>”) specifies the details of a compound element/block, in particular, panel 460 of FIG. 4B. It may be appreciated that the values “#DC143C” and “#808000” (the hexadecimal representations of the RGB triplets (220, 20, 60) and (128, 128, 0)) of the “back-color” attribute shown in data portions 615 and 625 respectively represents the source background color (455) and the source foreground color (465) of panel 460.

Thus, in response to a developer selecting panel 460 for importing into the new UI, UI tool 150 may inspect the specification of FIG. 6A to identify the source foreground and background colors of the selected element (panel 460). UI tool 150 may similarly inspect the specification of the new UI (described below) to identify the target background color.

Referring to FIG. 6B, data portion 640 specifies the details of the “new_screen” page/screen in a new UI. It may be observed that data portion 650 is similar to data portion 620 of FIG. 6A and is included in the new specification in response to the developer indicating the selection and importing of panel 460 into the new UI. The values “#EEC900” and “#928D6C” (the hexadecimal representations of the RGB triplets (238, 201, 0) and (146, 141, 108)) of the “back-color” attribute shown in data portions 645 and 655 respectively represents the target background color (475) and the computed target foreground color (485) of panel 460 in the new UI. The new specification may similarly incorporate the definitions of other elements selected/imported from other pre-existing user interfaces.

It should be appreciated that the features described above can be implemented in various embodiments as a desired combination of one or more of hardware, executable modules, and firmware. The description is continued with respect to an embodiment in which various features are operative when the software instructions described above are executed.

9. Digital Processing System

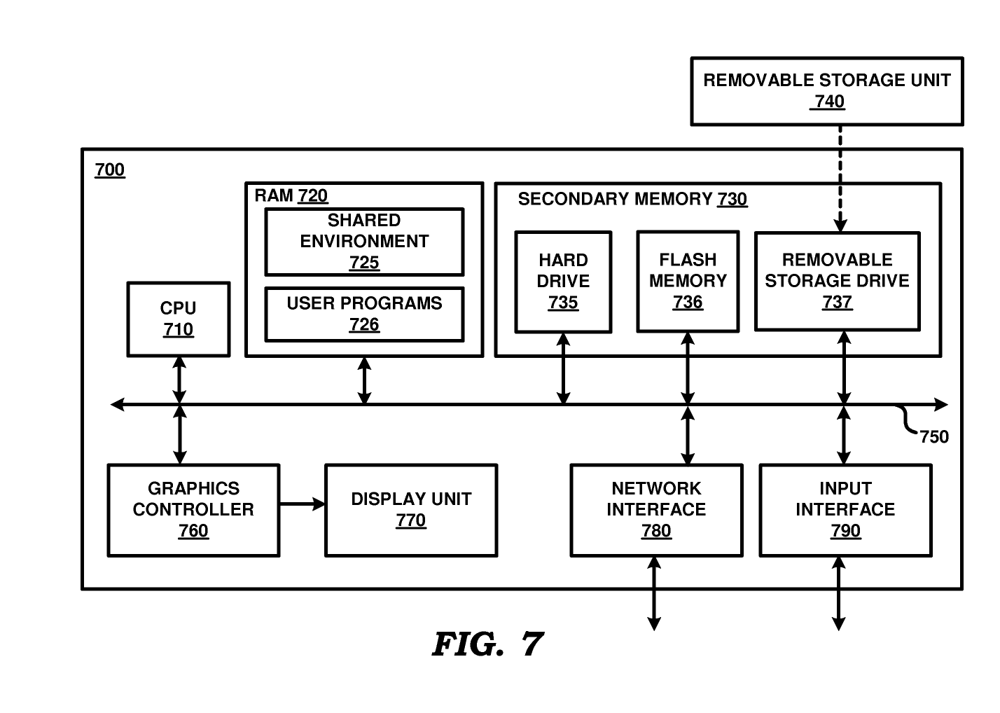

FIG. 7 is a block diagram illustrating the details of digital processing system 700 in which various aspects of the present invention are operative by execution of appropriate software instructions. Digital processing system 700 may correspond to any system (such as developer system 190) executing UI tool 150.

Digital processing system 700 may contain one or more processors (such as a central processing unit (CPU) 710), random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or user programs 726 (such as networking applications, database applications, etc.). Shared environment 725 contains utilities shared by user programs, and such shared utilities include operating system, device drivers, virtual machines, flow engine, etc., which provide a (common) run time environment for execution of user programs/applications 726.

Graphics controller 760 generates display signals (e.g., in RGB format) to display unit 770 based on data/instructions received from CPU 710. Display unit 770 contains a display screen to display the images defined by the display signals (such as the portions of the user interfaces shown in FIGS. 4A-4D). Input interface 790 may correspond to a keyboard and a pointing device (e.g., touch-pad, mouse) and may be used to provide the user inputs (such as the inputs, for example, selection of UI elements, specified in the portions of the user interface shown in FIGS. 4A-4D) required for several aspects of the present invention. Network interface 780 provides connectivity to a network (e.g., using Internet Protocol), and may be used to communicate with other connected systems (such as client systems 110A-110Z, server systems 160A-160C, data store 180, etc.) of FIG. 1.

Secondary memory 730 may contain hard drive 735, flash memory 736, and removable storage drive 737. Secondary memory 730 may store the data (for example, portions of the specifications shown in FIGS. 6A-6B) and software instructions (for example, for performing the steps of FIGS. 2 and 3 and the calculations of FIG. 5), which enable digital processing system 700 to provide several features in accordance with the present invention.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

10. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of facilitating development of user interfaces of applications, said method comprising:
enabling a user to select a first user interface (UI) element from a source interface, wherein said first UI element is displayed using a source foreground color in a backdrop of a source background color in said source interface;
receiving a target background color forming a backdrop to said first UI element in a target interface;
computing a target foreground color based on said target background color and a color difference between said source background color and said source foreground color; and
displaying said first UI element in said target interface using said target foreground color and said target background color.

2. The method of claim 1, wherein each color comprises a set of constituent colors, each constituent color having a corresponding value, wherein said computing further comprises:
determining a first set of values, a second set of values and a third set of values of said set of constituent colors respectively for said source background color, said source foreground color, and said target background color;
finding a set of distances as the difference between the corresponding values of said set of constituent colors in said first set of values and said second set of values,
wherein said set of distances corresponding to said set of constituent colors represents said color difference between said source background color and said source foreground color; and
forming a fourth set of values for said target foreground color based on the corresponding values of said set of constituent colors in said third set of values and said set of distances.

3. The method of claim 2, wherein said forming comprises:
arranging said set of constituent colors for said source background color in a first order of dominance, and said set of constituent colors for said target background color in a second order of dominance, wherein a first constituent color is assigned a higher position than a second constituent color in each order of dominance if the corresponding value of the first constituent color is greater than or equal to the corresponding value of the second constituent color;
identifying a first dominant color of said first order of dominance, and a second dominant color of said second order of dominance, wherein both of said first dominant color and said second dominant color are in a same specific position in the respective orders;
calculating the corresponding value of said second dominant color in said fourth set of values based on the corresponding value of said second dominant color in said third set of values and a specific one of said set of distances corresponding to said first dominant color; and
iteratively performing said identifying and said calculating for each position in the respective orders until all of said fourth set of values of said set of constituent colors are determined.

4. The method of claim 3, wherein said calculating comprises:
comparing the values of said first dominant color and said second dominant color in each iteration to determine whether said first dominant color and said second dominant color are in the same zone in the color spectrum, wherein the color spectrum is defined as a range of values and each zone is defined as a corresponding specific sub-range of said range of values;
if said first dominant color and said second dominant color are determined to be in the same zone, computing the corresponding value of said second dominant color in said fourth set of values as the difference of corresponding value of said second dominant color and said specific one of said set of distances corresponding to said first dominant color; and
otherwise, calculating the corresponding value of said second dominant color in said fourth set of values as the sum of corresponding value of said second dominant color and said specific one of said set of distances corresponding to said first dominant color.

5. The method of claim 4, wherein said set of constituent colors comprises a red color, a green color and a blue color,
each of said red color, said green color and said blue color having a corresponding value in the color spectrum of 0 to 255,
wherein the color spectrum is divided into two zones with sub-ranges of 0 to 127 and 128 to 255.

6. The method of claim 1, wherein each of the user interfaces is specified by a corresponding specification, wherein said source interface is specified by a source specification, said method further comprising:
inspecting, in response to said user selecting said first UI element, said source specification to identify said source foreground color and said source background color of said first UI element.

7. The method of claim 6, wherein said target interface is specified by a target specification, said method further comprising:
after said computing, incorporating in said target specification, said first UI element as having said target foreground color and said target background color.

8. A non-transitory machine readable medium storing one or more sequences of instructions for causing a system to facilitate development of user interfaces of applications, wherein execution of said one or more instructions by one or more processors contained in said system causes said system to perform the actions of:
enabling a user to select a first user interface (UI) element from a source interface, wherein said first UI element is displayed using a source foreground color in a backdrop of a source background color in said source interface;
receiving a target background color forming a backdrop to said first UI element in a target interface;
computing a target foreground color based on said target background color and a color difference between said source background color and said source foreground color; and
displaying said first UI element in said target interface using said target foreground color and said target background color.

9. The machine readable medium of claim 8, wherein each color comprises a set of constituent colors, each constituent color having a corresponding value, wherein said computing further comprises one or more instructions for:
determining a first set of values, a second set of values and a third set of values of said set of constituent colors respectively for said source background color, said source foreground color, and said target background color;
finding a set of distances as the difference between the corresponding values of said set of constituent colors in said first set of values and said second set of values,
wherein said set of distances corresponding to said set of constituent colors represents said color difference between said source background color and said source foreground color; and
forming a fourth set of values for said target foreground color based on the corresponding values of said set of constituent colors in said third set of values and said set of distances.

10. The machine readable medium of claim 9, wherein said forming comprises one or more instructions for:
arranging said set of constituent colors for said source background color in a first order of dominance, and said set of constituent colors for said target background color in a second order of dominance, wherein a first constituent color is assigned a higher position than a second constituent color in each order of dominance if the corresponding value of the first constituent color is greater than or equal to the corresponding value of the second constituent color;
identifying a first dominant color of said first order of dominance, and a second dominant color of said second order of dominance, wherein both of said first dominant color and said second dominant color are in a same specific position in the respective orders;
calculating the corresponding value of said second dominant color in said fourth set of values based on the corresponding value of said second dominant color in said third set of values and a specific one of said set of distances corresponding to said first dominant color; and
iteratively performing said identifying and said calculating for each position in the respective orders until all of said fourth set of values of said set of constituent colors are determined.

11. The machine readable medium of claim 10, wherein said calculating comprises one or more instructions for:
comparing the values of said first dominant color and said second dominant color in each iteration to determine whether said first dominant color and said second dominant color are in the same zone in the color spectrum, wherein the color spectrum is defined as a range of values and each zone is defined as a corresponding specific sub-range of said range of values;
if said first dominant color and said second dominant color are determined to be in the same zone, computing the corresponding value of said second dominant color in said fourth set of values as the difference of corresponding value of said second dominant color and said specific one of said set of distances corresponding to said first dominant color; and
otherwise, calculating the corresponding value of said second dominant color in said fourth set of values as the sum of corresponding value of said second dominant color and said specific one of said set of distances corresponding to said first dominant color.

12. The machine readable medium of claim 11, wherein said set of constituent colors comprises a red color, a green color and a blue color,
each of said red color, said green color and said blue color having a corresponding value in the color spectrum of 0 to 255,
wherein the color spectrum is divided into two zones with sub-ranges of 0 to 127 and 128 to 255.

13. The machine readable medium of claim 8, wherein each of the user interfaces is specified by a corresponding specification, wherein said source interface is specified by a source specification, further comprising one or more instructions for:
inspecting, in response to said user selecting said first UI element, said source specification to identify said source foreground color and said source background color of said first UI element.

14. The machine readable medium of claim 13, wherein said target interface is specified by a target specification, further comprising one or more instructions for:
after said computing, incorporating in said target specification, said first UI element as having said target foreground color and said target background color.

15. A digital processing system comprising:
a processor;
a random access memory (RAM);
a machine readable medium to store one or more instructions, which when retrieved into said RAM and executed by said processor causes said digital processing system to facilitate development of user interfaces of applications, said digital processing system performing the actions of:
enabling a user to select a first user interface (UI) element from a source interface, wherein said first UI element is displayed using a source foreground color in a backdrop of a source background color in said source interface;
receiving a target background color forming a backdrop to said first UI element in a target interface;
computing a target foreground color based on said target background color and a color difference between said source background color and said source foreground color; and
displaying said first UI element in said target interface using said target foreground color and said target background color.

16. The digital processing system of claim 15, wherein each color comprises a set of constituent colors, each constituent color having a corresponding value, wherein for said computing, said digital processing system performs the actions of:
determining a first set of values, a second set of values and a third set of values of said set of constituent colors respectively for said source background color, said source foreground color, and said target background color;
finding a set of distances as the difference between the corresponding values of said set of constituent colors in said first set of values and said second set of values,
wherein said set of distances corresponding to said set of constituent colors represents said color difference between said source background color and said source foreground color; and
forming a fourth set of values for said target foreground color based on the corresponding values of said set of constituent colors in said third set of values and said set of distances.

17. The digital processing system of claim 16, wherein for said forming, said digital processing system performs the actions of:
arranging said set of constituent colors for said source background color in a first order of dominance, and said set of constituent colors for said target background color in a second order of dominance, wherein a first constituent color is assigned a higher position than a second constituent color in each order of dominance if the corresponding value of the first constituent color is greater than or equal to the corresponding value of the second constituent color;
identifying a first dominant color of said first order of dominance, and a second dominant color of said second order of dominance, wherein both of said first dominant color and said second dominant color are in a same specific position in the respective orders;
calculating the corresponding value of said second dominant color in said fourth set of values based on the corresponding value of said second dominant color in said third set of values and a specific one of said set of distances corresponding to said first dominant color; and
iteratively performing said identifying and said calculating for each position in the respective orders until all of said fourth set of values of said set of constituent colors are determined.

18. The digital processing system of claim 17, wherein for said calculating, said digital processing system performs the actions of:
comparing the values of said first dominant color and said second dominant color in each iteration to determine whether said first dominant color and said second dominant color are in the same zone in the color spectrum, wherein the color spectrum is defined as a range of values and each zone is defined as a corresponding specific sub-range of said range of values;
if said first dominant color and said second dominant color are determined to be in the same zone, computing the corresponding value of said second dominant color in said fourth set of values as the difference of corresponding value of said second dominant color and said specific one of said set of distances corresponding to said first dominant color; and
otherwise, calculating the corresponding value of said second dominant color in said fourth set of values as the sum of corresponding value of said second dominant color and said specific one of said set of distances corresponding to said first dominant color.

19. The digital processing system of claim 18, wherein said set of constituent colors comprises a red color, a green color and a blue color,
each of said red color, said green color and said blue color having a corresponding value in the color spectrum of 0 to 255,
wherein the color spectrum is divided into two zones with sub-ranges of 0 to 127 and 128 to 255.

20. The digital processing system of claim 15, wherein each of the user interfaces is specified by a corresponding specification, wherein said source interface is specified by a source specification, wherein said target interface is specified by a target specification, said digital processing system further performing the actions of:
inspecting, in response to said user selecting said first UI element, said source specification to identify said source foreground color and said source background color of said first UI element; and
after said computing, incorporating in said target specification, said first UI element as having said target foreground color and said target background color.
